(19) United States
(12) Patent Application Publication
(10) Pub. No.: US 2017/0197337 A1
(43) Pub. Date: Jul. 13, 2017

(54) FORMING METHOD FOR COOLING SYSTEM OF RAPID HEATING MOLD

(71) Applicant: CHUNG-NAN LIU, Yunlin County (CN)

(72) Inventor: CHUNG-NAN LIU, Yunlin County (CN)

(21) Appl. No.: 15/314,360

(22) PCT Filed: May 21, 2015
(86) PCT No.: PCT/CN2015/079470

§ 371 Date: Nov. 28, 2016

(30) Foreign Application Priority Data
May 28, 2014 (CN) 201410231082.0

(51) Int. Cl. B29C 33/38; B29C 67/00; B22C 9/06; B33Y 40/00; B33Y 80/00; B29C 33/04; B33Y 10/00

(52) U.S. Cl. CPC B29C 33/3842; B29C 33/04; B29C 67/0051; B33Y 10/00; B33Y 40/00; B33Y 80/00; B22C 9/065; B29L 2031/757

(57) ABSTRACT

A forming method for a cooling system of a rapid heating mold comprises: preparing a solid cooling waterway object (30) of a default cooling waterway, the solid cooling waterway object (30) comprising multiple interconnected attachment portions (31) and multiple subbranch portions (32); placing the solid cooling waterway object (30) into a container (40) provided with a perfusion groove (41), and the attaching the attachment portions (31) onto a groove bottom surface (411) of the perfusion groove (41); preparing a perfusion material, and perfusing the perfusion material into the perfusion groove (41) of the container (40) to form a mold fixing layer (50) of the solid cooling waterway object (30) after cooling; and taking out the mold fixing layer (50), heating the mold fixing layer (50), enabling the solid cooling waterway object (30) to be in a gas state or a liquid state, and discharging the object in the gas state or the liquid state, so as to form a cooling waterway (52) corresponding to the solid cooling waterway object (30). Accordingly, a cooling waterway in any form can be formed on the mold upon needs, and the effects that the cooling waterway is easy to treat and the heat dissipation temperature of the mold is uniform are achieved.

### BACKGROUND OF THE INVENTION

Field of the Invention

The present invention relates to a rapid heating mold, and more particularly to a forming method for a cooling system of a rapid heating mold.

Related Prior Art

When a mold is used for plastic injection molding, aluminum alloy casting, magnesium alloy casting, and etc, rapid heating system of the molds can improve the molding quality and reduce the production cycle.

For example, when a mold is used in plastic injecting molding, to make the plastic melt flow smoothly into the sprue gate of the mold, and to ensure stable flow and prevent the plastic melt from getting colds and solidifying too early, before mold closing, the rapid heating system should heat the male mold or female mold to a predetermined temperature to make sure that the plastic melt can flow smoothly to the mold cavity, and then dries into a product.

Similarly, with the cooling system in the mold, the material in the mold cavity can cool down and solidify rapidly, which consequently reduces the production cycle. FIG. 1 shows a mold (which is an upper mold 10 for example) with a cooling system, wherein the upper mold 10 includes: a mold fixing layer 11, a mold layer 12 disposed on the mold fixing layer 11, and a plurality of cooling waterways 111 disposed on the mold fixing layer 11. The cooling waterways 111 contain cooling liquid, which can carry away the heat of the mold layer 12, and thus mold layer 12 is cooled down rapidly. However, there are still some disadvantages in actual application:

The mold fixing layer 11 and the mold layer 12 of the upper mold 10 are all made of steel. Besides, it should form the mold fixing layer 11 first, and then the molding fixing layer 11 should be processed to form the cooling waterways 111. Therefore, the processing is too difficult, and is unfit for the mold surface 121 of the mold layer 12 which is in the form of a complicated three dimensional geometry or a free form surface. Therefore, it is not easy for the cooling waterways 111 to be located close to the mold surface 121 of the mold layer 12, resulting in uneven temperature distribution in the surface of the upper mold 10.

The present invention has arisen to mitigate and/or obviate the afore-described disadvantages.

### SUMMARY

One objective of the present invention is to provide a forming method for a cooling system of a rapid heating mold, which is capable of forming any shaped cooling waterway as desired, and the cooling waterway is located close to the mold surface of the mold layer, achieving the advantages of easy manufacturing of the cooling waterway, and uniform cooling temperature distribution of the mold.

To achieve the above objective, a forming method for a cooling system of a rapid heating mold, characterized in that comprises:

a step of preparing including: preparing a solid cooling waterway object of a default cooling waterway, the solid cooling waterway object comprises multiple interconnected attachment portions and multiple subbranch portions;

a step of placing including: placing the solid cooling waterway object into a container with a perfusion groove, and abutting the attachment portions against a groove bottom surface of the perfusion groove;

a step of perfusion molding including: preparing a perfusion material, perfusing the perfusion material into the perfusion groove of the container to form a mold fixing layer for covering the solid cooling waterway object after cooling; and

a step of removing including: taking out the mold fixing layer and processing the mold fixing layer to turn the solid cooling waterway object into liquid or gas which is discharged out of the mold fixing layer, so as to form a cooling waterway corresponding to the solid cooling waterway object in the mold fixing layer.

Preferably, the solid cooling watery object is made by 3D printing, and there are intervals between the attachment portions of the solid cooling waterway object.

Preferably, the step of perfusion molding includes: preparing a perfusion material whose melting point is higher than a melting point of the solid cooling waterway object, and the step of removing is to heat the mold fixing layer with a temperature lower than a melting point of the mold fixing layer and higher than the melting point of the solid cooling waterway object.

Preferably, the step of perfusion molding is to prepare a perfusion material which is less corrosive than the solid cooling waterway object, the step of removing is to soak the mold fixing layer in a corrosive solution, and the corrosive solution does not erode the mold fixing layer but erodes the solid cooling waterway object only.

Preferably, the attachment portions of the solid cooling waterway object each include cooling grooves, and each of the subbranch portions includes cooling passages which communicate with the cooling grooves, so as to form the cooling waterway.

To achieve the above objective, a forming method for a cooling system of a rapid heating mold, characterized in that comprises:

a step of preparing including: preparing a solid cooling waterway object, the solid cooling waterway object comprises multiple interconnected attachment portions and multiple subbranch portions, the attachment portions of the solid cooling waterway object each include cooling grooves, and each of the subbranch portions includes cooling passages which communicate with the cooling grooves, so as to form a cooling waterway;

a step of placing including: placing the solid cooling waterway object into a container with a perfusion groove, and abutting the attachment portions against a groove bottom surface of the perfusion groove; and

a step of perfusion molding including: perfusing a perfusion material into the perfusion groove of the container to form a mold fixing layer for covering the solid cooling waterway object after the perfusion material cools down, so that the mold fixing layer is provided with the cooling waterway formed by the cooling passages and the cooling grooves.

Preferably, the solid cooling watery object is made by 3D printing, and there are intervals between the attachment portions of the solid cooling waterway object.

To achieve the above objective, a forming method for a cooling system of a rapid heating mold, characterized in that comprises:

a step of preparing including: preparing a container with a perfusion groove, and a solid cooling waterway object of a default cooling waterway integrally formed in the perfusion groove, the solid cooling waterway object comprises multiple interconnected attachment portions and multiple subbranch portions, and the attachment portions are formed in a groove bottom surface of the perfusion groove;

a step of perfusion molding including: preparing a perfusion material, and perfusing the perfusion material into the perfusion groove of the container to form a mold fixing layer for covering the solid cooling waterway object after cooling; and

a step of removing including: processing the mold fixing layer to turn the solid cooling waterway object and the container into a liquid or gas which is discharged out of the mold fixing layer, so as to form a cooling waterway corresponding to the solid cooling waterway object in the mold fixing layer.

Preferably, the solid cooling watery object and the container are made by 3D printing, and there are intervals between the attachment portions of the solid cooling waterway object.

Preferably, the step of perfusion molding is to prepare a perfusion material whose melting point is higher than melting points of the container and the solid cooling waterway object, and the step of removing is to heat the mold fixing layer with a temperature lower than the melting point of the mold fixing layer and higher than the melting points of the container and the solid cooling waterway object.

Preferably, the step of perfusion molding is to prepare a perfusion material which is less corrosive than the solid cooling waterway object and the container, the step of removing is to soak the mold fixing layer in a corrosive solution, and the corrosive solution does not erode the mold fixing layer but erodes the solid cooling waterway object and the container only.

To achieve the above objective, a forming method for a cooling system of a rapid heating mold, characterized in that comprises:

a step of preparing including: preparing a container with a perfusion groove, a solid cooling waterway object of a default cooling waterway integrally formed in the perfusion groove, the solid cooling waterway object comprises multiple interconnected attachment portions and multiple subbranch portions, and the attachment portions are formed in the groove bottom surface of the perfusion groove and include cooling grooves, each of the subbranch portions includes cooling passages which communicate with the cooling grooves, so as to form a cooling waterway;

a step of perfusion molding including: perfusing a perfusion material into the perfusion groove of the container to form a mold fixing layer for covering the solid cooling waterway object after cooling, so that the mold fixing layer is provided with the cooling waterway formed by the cooling passages and the cooling grooves; and

a step of trimming and forming including: trimming the container, so that the cooling grooves and at least one of the cooling passages in the mold fixing layer communicate with outside.

Preferably, the solid cooling watery object and the container are made by 3D printing, and there are intervals between the attachment portions of the solid cooling waterway object.

### BRIEF DESCRIPTION OF THE DRAWINGS

FIG. 1 is a cross sectional view of a conventional mold with cooling system;

FIG. 2 is a flow chart showing the steps of a forming method for a cooling system of a rapid heating mold in accordance with a first embodiment of the present invention;

FIG. 3-1 is a perspective view showing the solid cooling waterway object in the step of preparing of the forming method for cooling system of rapid heating mold in accordance with the first embodiment of the present invention;

FIG. 3-2 is a partial cross sectional view showing the solid cooling waterway object in the step of preparing of the forming method for cooling system of rapid heating mold in accordance with the first embodiment of the present invention;

FIG. 3-3 is a perspective view from another angle showing the solid cooling waterway object in the step of preparing of the forming method for cooling system of rapid heating mold in accordance with the first embodiment of the present invention;

FIG. 4-1 is a perspective view of the forming method for cooling system of rapid heating mold in accordance with the first embodiment of the present invention, showing that the step of placing the solid cooling waterway object in the container;

FIG. 4-2 is a cross sectional view of the forming method for cooling system of rapid heating mold in accordance with the first embodiment of the present invention, showing that the step of placing the solid cooling waterway object in the container;

FIG. 5 is an illustrative view of the forming method for cooling system of rapid heating mold in accordance with the first embodiment of the present invention, showing that the step of perfusion molding, wherein a mold fixing layer is formed to cover the solid cooling waterway object;

FIG. 6-1 is an illustrative view of the forming method for cooling system of rapid heating mold in accordance with the first embodiment of the present invention, showing the step of heating the mold fixing layer to form the cooling waterway;

FIG. 6-2 is a cross sectional view of the forming method for cooling system of rapid heating mold in accordance with the first embodiment of the present invention, showing the step of heating the mold fixing layer to form the cooling waterway;

FIG. 7-1 is an exploded view of the forming method for cooling system of rapid heating mold in accordance with the first embodiment of the present invention, showing that the mold fixing layer is separated from the mold layer;

FIG. 7-2 is an illustrative view of the forming method for cooling system of rapid heating mold in accordance with the first embodiment of the present invention, showing that the mold fixing layer is assembled to the mold layer;

FIG. 8-1 is a partial exploded view of the forming method for cooling system of rapid heating mold in accordance with the first embodiment of the present invention, showing that the mold fixing layer is separated from the mold layer;

FIG. 8-2 is an illustrative view of the forming method for cooling system of rapid heating mold in accordance with the first embodiment of the present invention, showing that the mold fixing layer is assembled to the mold layer;

FIG. 9 is a cross sectional view of the forming method for cooling system of rapid heating mold in accordance with the first embodiment of the present invention, showing that the mold fixing layer is a lower mold;

FIG. 10-1 is a cross sectional view of the forming method for cooling system of rapid heating mold in accordance with a second embodiment of the present invention, showing that the solid cooling waterway object is provided with two inserting holes;

FIG. 10-2 is a cross sectional view of the forming method for cooling system of rapid heating mold in accordance with the second embodiment of the present invention, showing that the mold fixing layer is provided with two support portions;

FIG. 11 is a flow chart showing the steps of a forming method for a cooling system of a rapid heating mold in accordance with a fourth embodiment of the present invention;

FIG. 12-1 is a cross sectional view showing the solid cooling waterway object in the step of preparing of the forming method for cooling system of rapid heating mold in accordance with the fourth embodiment of the present invention;

FIG. 12-2 is a cross sectional view showing the step of placing of the forming method for cooling system of rapid heating mold in accordance with the fourth embodiment of the present invention, wherein the solid cooling waterway object is disposed in the container;

FIG. 12-3 is a cross sectional view showing the step of perfusion molding of the forming method for cooling system of rapid heating mold in accordance with the fourth embodiment of the present invention, wherein the mold fixing layer covers the solid cooling waterway object;

FIG. 12-4 is a cross sectional view of the forming method for cooling system of rapid heating mold in accordance with the fourth embodiment of the present invention, showing that mold is disposed on the mold fixing layer;

FIG. 13-1 is an illustrative view of the forming method for cooling system of rapid heating mold in accordance with a fifth embodiment of the present invention, showing that the solid cooling waterway object is provided with two support portions;

FIG. 13-2 is an illustrative view of the forming method for cooling system of rapid heating mold in accordance with the fifth embodiment of the present invention, showing that the mold fixing layer is provided with two support portions;

FIG. 14 is an illustrative view of the forming method for cooling system of rapid heating mold in accordance with a sixth embodiment of the present invention;

FIG. 15 is a flow chart showing the steps of a forming method for a cooling system of a rapid heating mold in accordance with a seventh embodiment of the present invention;

FIG. 16-1 is a cross sectional view of the step of preparing in accordance with the seventh embodiment of the present invention;

FIG. 16-2 is a cross sectional view of the step of perfusion molding in accordance with the seventh embodiment of the present invention;

FIG. 16-3 is a cross sectional view of the step of heating in accordance with the seventh embodiment of the present invention;

FIG. 17 is a flow chart showing the steps of a forming method for a cooling system of a rapid heating mold in accordance with an eighth embodiment of the present invention;

FIG. 18-1 is a cross sectional view of the step of preparing in accordance with the eighth embodiment of the present invention;

FIG. 18-2 is a cross sectional view of the step of perfusion molding in accordance with the eighth embodiment of the present invention; and

FIG. 18-3 is a cross sectional view of the step of trimming in accordance with the eighth embodiment of the present invention.

### DESCRIPTION OF REFERENCE NUMERALS

10 upper mold
11 mold fixing layer
111 cooling waterway
12 mold layer
121 mold surface
21 step of preparing
22 step of placing
23 step of perfusion molding
24 step of removing
25 step of trimming and forming
30 solid cooling waterway object
31 attachment portion
311 outer surface
312 inserting hole
313 shrink end
314 cooling groove
3141 support portion
3142 shrink end
32 subbranch portion
321 cooling passage
33 interval
40 container
41 perfusion groove
411 groove bottom surface
50 mold fixing layer
51 fixing layer mold surface
52 cooling waterway
521 cooling groove
5211 end portion
522 cooling passage
523 support portion
60 mold layer
61 inner mold surface

### DETAILED DESCRIPTION

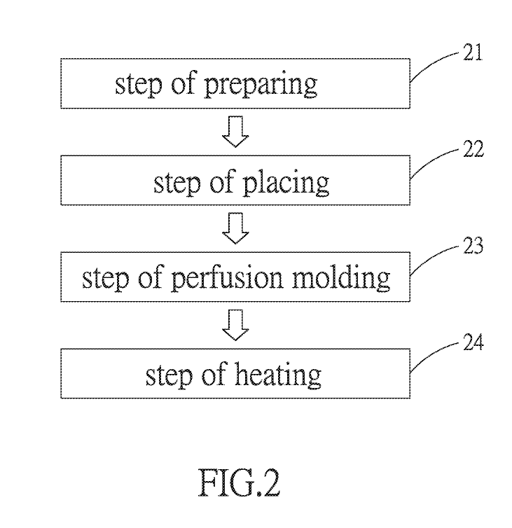

Referring to FIG. 2, a forming method for a cooling system of a rapid heating mold in accordance with the first embodiment of the present invention comprises: a step 21 of preparing, a step 22 of placing, a step 23 of perfusion molding, and a step 24 of removing.

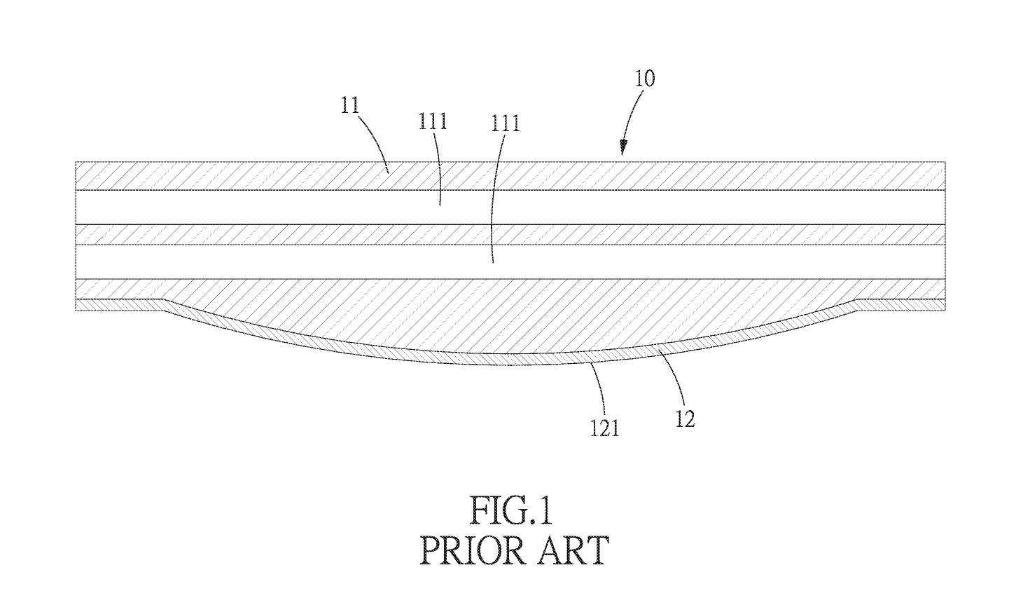

As shown in FIGS. 3-1, 3-2 and 3-3, the step of preparing includes: preparing a solid cooling waterway object 30 of a default cooling waterway, the solid cooling waterway object 30 comprises multiple interconnected attachment portions 31 and multiple subbranch portions 32. In this embodiment, the solid cooling watery object 30 is made by 3D printing, which is only for illustrative, not for restrictive purposes. There are intervals 33 between the attachment portions 31 of the solid cooling waterway object 30, and the outer surfaces 311 of the attachment portions 31 of the solid cooling waterway object 30 are in the mold abutting surface (not shown) of a predetermined shape.

Referring to FIGS. 4-1 and 4-2, the step of placing includes: placing the solid cooling waterway object 30 into a container 40 with a perfusion groove 41, and abutting the outer surfaces 311 of the attachment portions 31 against the groove bottom surface 411 of the perfusion groove 41, namely, the groove bottom surface 411 is the mold abutting surface.

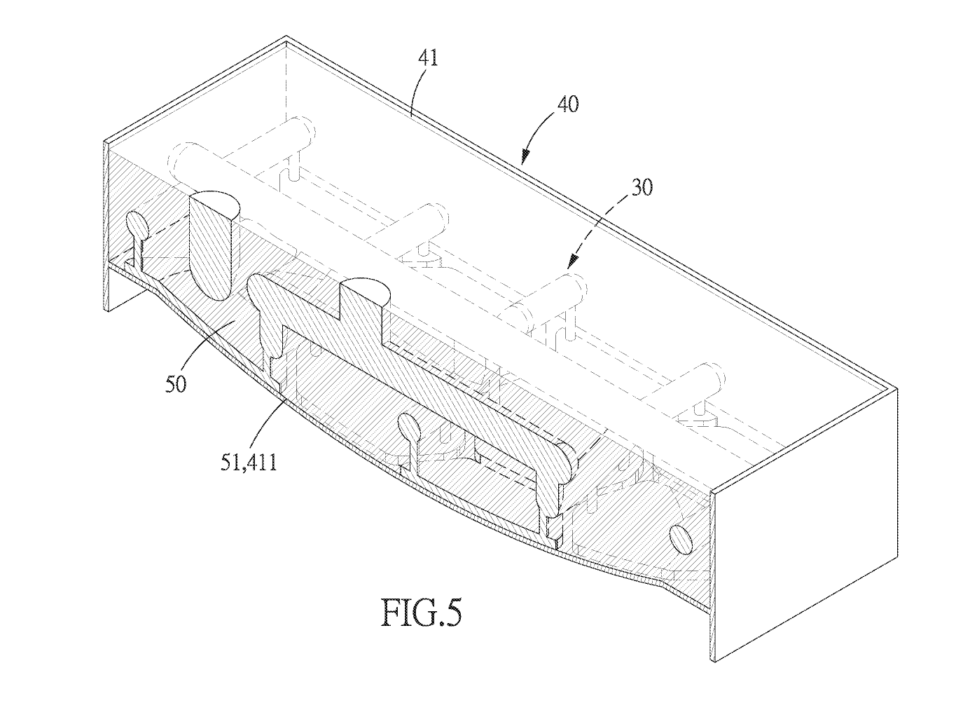

Referring to FIG. 5, the step of perfusion molding includes: preparing a perfusion material whose melting point is lower than the melting point of the solid cooling waterway object 30, perfusing the perfusion material into the perfusion groove 41 of the container 40 to form a mold fixing layer 50 for covering the solid cooling waterway object 30 after cooling, wherein the mold fixing layer 50 further includes a fixing layer mold surface 51 to abut against the groove bottom surface 411 of the perfusion groove 41.

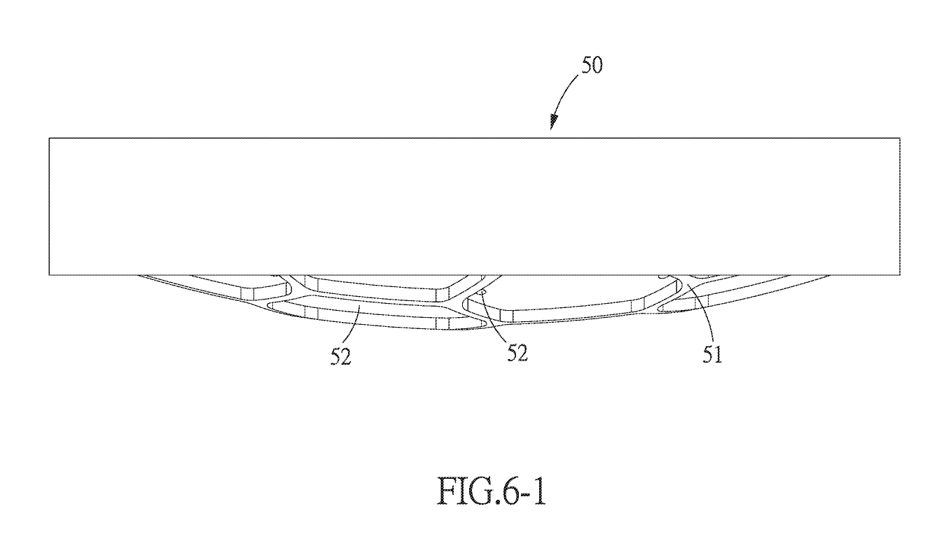

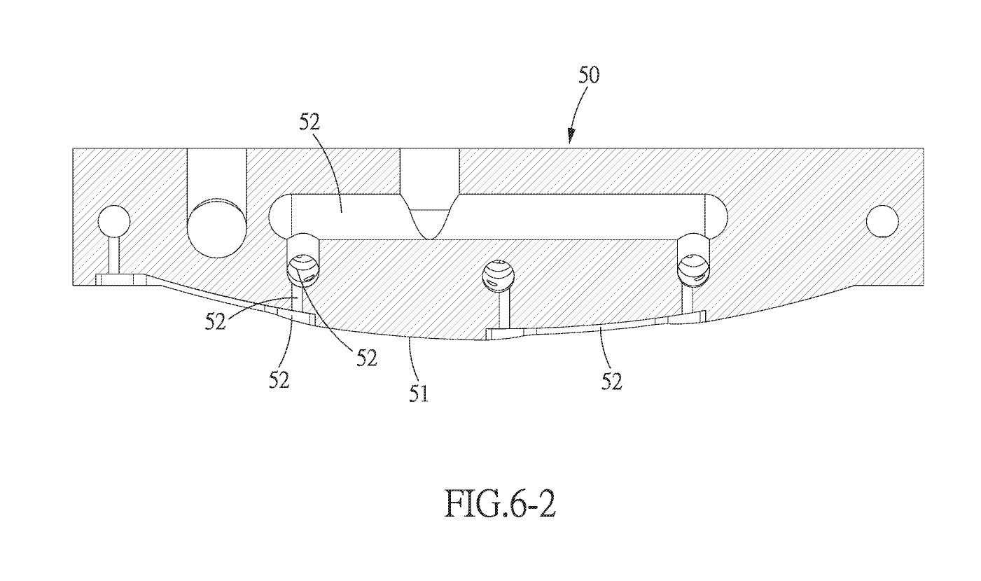

Referring to FIGS. 6-1 and 6-2, the step of removing includes: taking out the mold fixing layer 50 and heating it with a temperature lower than the melting point of the mold fixing layer 50 and higher than the melting point of the solid cooling waterway object 30, so that the solid cooling waterway object 30 is heated into a liquid or gas state and discharged out of the mold fixing layer 50, so as to form a cooling waterway 52 corresponding to the solid cooling waterway object 30 in the mold fixing layer 50, and the cooling waterway 52 is provided with cooling grooves 521 in the shape of the attachment portions 31 and the cooling passages 522 in the shape of the subbranch portions 32.

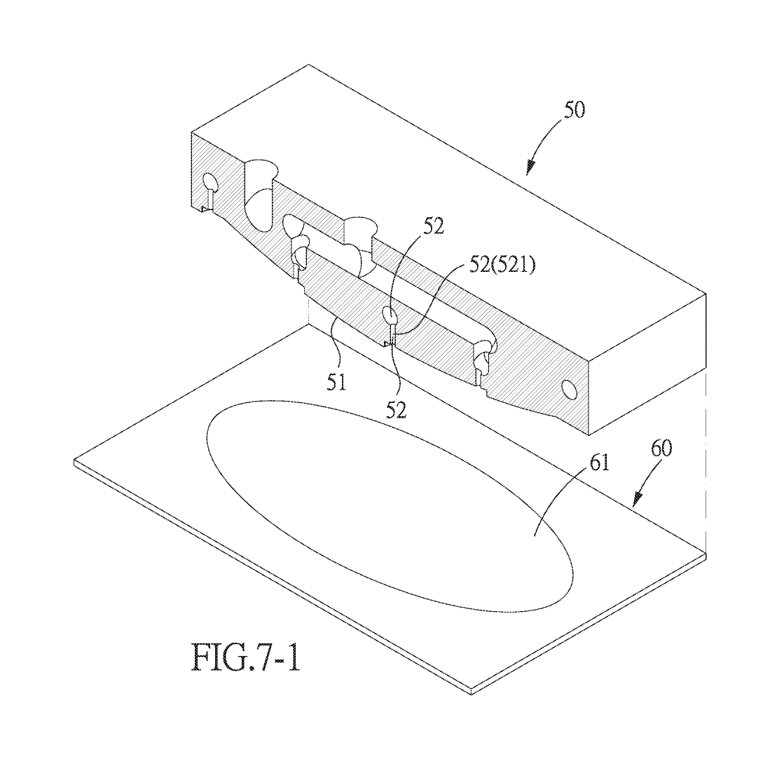

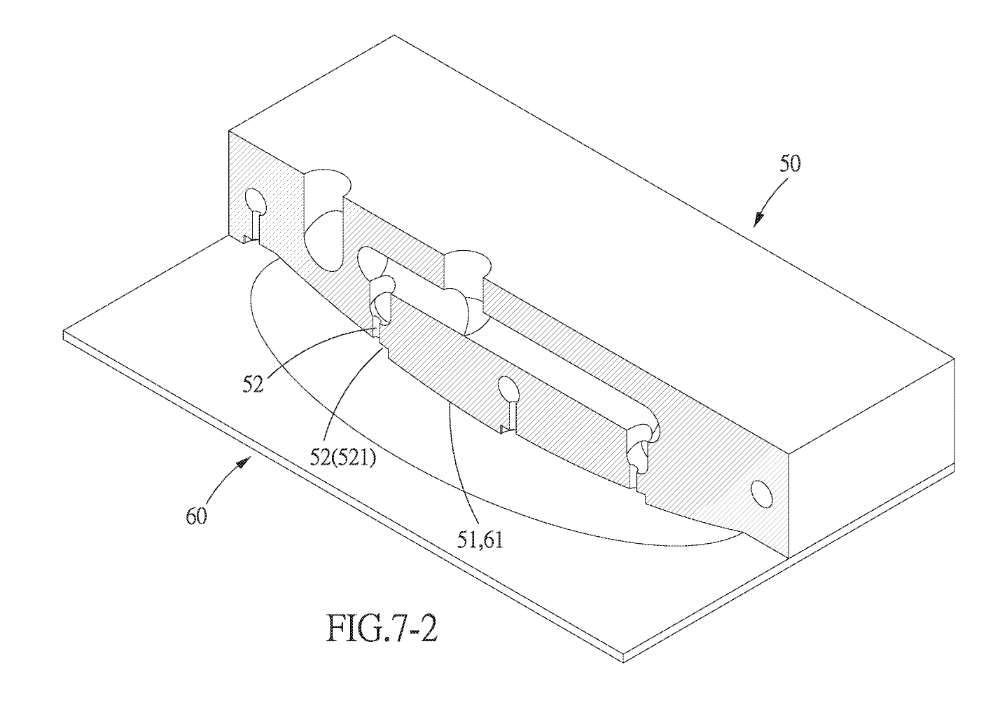

In this embodiment, as shown in FIGS. 7-1, 7-2, 8-1 and 8-2, after the step of removing, the fixing layer mold surface 51 of the mold fixing layer 50 is abutted against an inner mold surface 61 of the mold layer 60, so that the cooling waterway 52 (the cooling grooves 521) of the mold fixing layer 50 runs through the inner mold surface 61 of the mold layer 60.

What mentioned above are the main steps of the embodiment of the present invention, for a better understanding of the invention, reference should be made to the following descriptions.

With the forming method for a cooling system of a rapid heating mold in accordance with the present invention, the path of the cooling waterway 52 of the mold fixing layer 50 can be designed as desired to fit the mold surface of the mold layer 60 which is in the form of a complicated three dimensional geometry or a free form surface. Besides, the path of the cooling waterway 52 of the mold fixing layer 50 can run through the mold layer 60 to allow the waterway 52 to be located close to the mold surface of the mold layer 60, which achieves the advantages of easy manufacturing of the cooling waterway 52, and uniform cooling temperature distribution.

It is to be noted that, in the step 23 of perfusion molding, the mold fixing layer 50 further comprises the fixing layer mold surface 51, and before the step 24 of heating, the fixing layer mold surface 51 is abutted against the inner mold surface 61 of the mold layer 60, so that the cooling waterway 52 of the mold fixing layer 50 runs through the inner mold surface 61 of the mold layer 60 after the step 24 of removing. Namely, when the mold fixing layer 50 and the mold layer 60 are fixed to each other before the solid cooling waterway object 30 melts, the waterway 52 can also be located close to the mold surface of the mold layer 60, which also achieves the same advantages of easy manufacturing of the cooling waterway 52, and uniform cooling temperature distribution. Of course, the mold layer 60 must have a melting point higher than the melting point of the solid cooling waterway object 30.

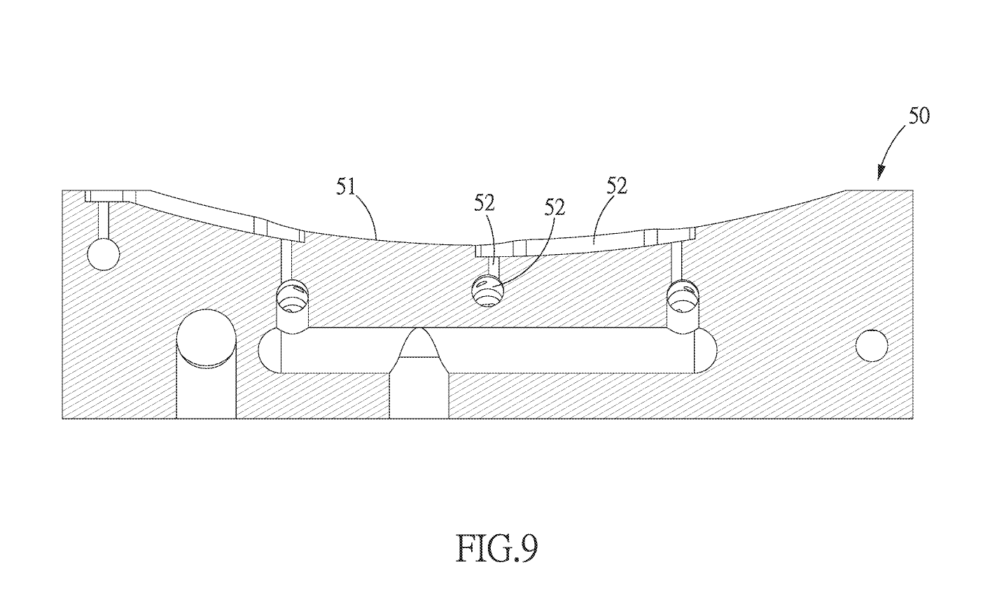

Referring then to FIG. 9, the forming method for a cooling system of a rapid heating mold in accordance with the present invention can also be used when the mold fixing layer 50 is a lower mold and also provided with the cooling waterway 52 and the fixing layer mold surface 51.

It is to be noted that the forming method for a cooling system of a rapid heating mold in accordance with the first embodiment of the present invention, in the step 23 of perfusion molding, prepares a perfusion material which is less corrosive than the solid cooling waterway object 30. In the step 24 of removing, the mold fixing layer 50 is soaked with corrosive solution, and the corrosive solution does not erode the mold fixing layer 50 but erodes the solid cooling waterway object 30 only. In this way, the solid cooling waterway object 30 can also be turned into liquid or gas and discharged out of the mold fixing layer 50, so as to form the cooling waterway 52 in the shape of the solid cooling waterway object 30 in the mold fixing layer 50, and the cooling waterway 52 is provided with cooling grooves 521 in the shape of the attachment portions 31 and the cooling passages in the shape of the subbranch portions 32.

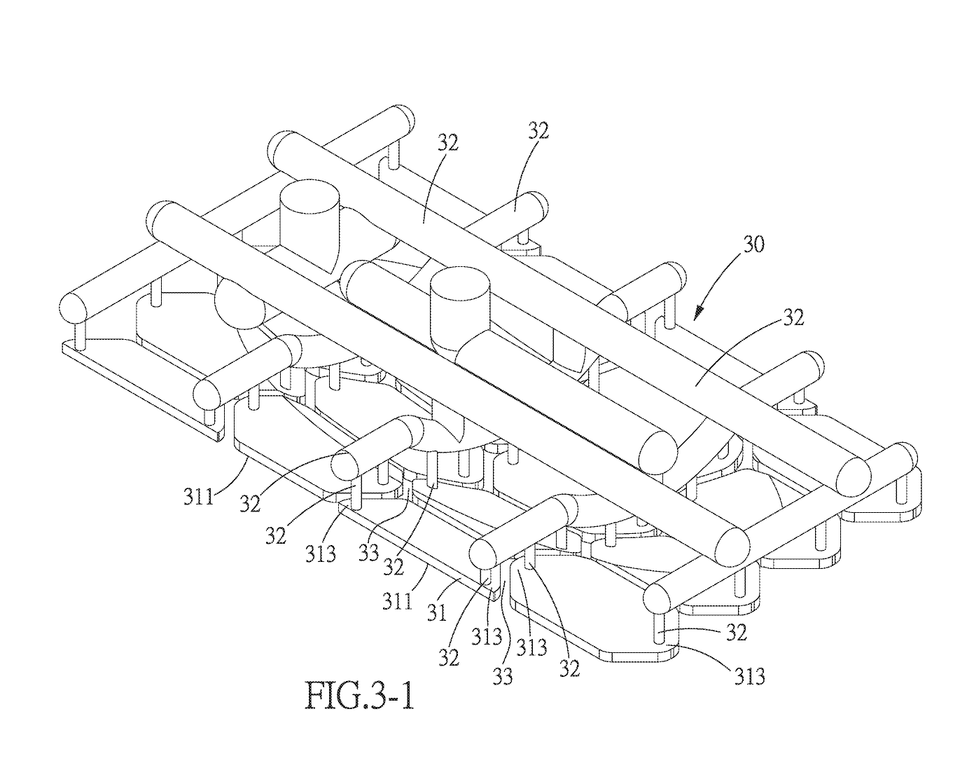

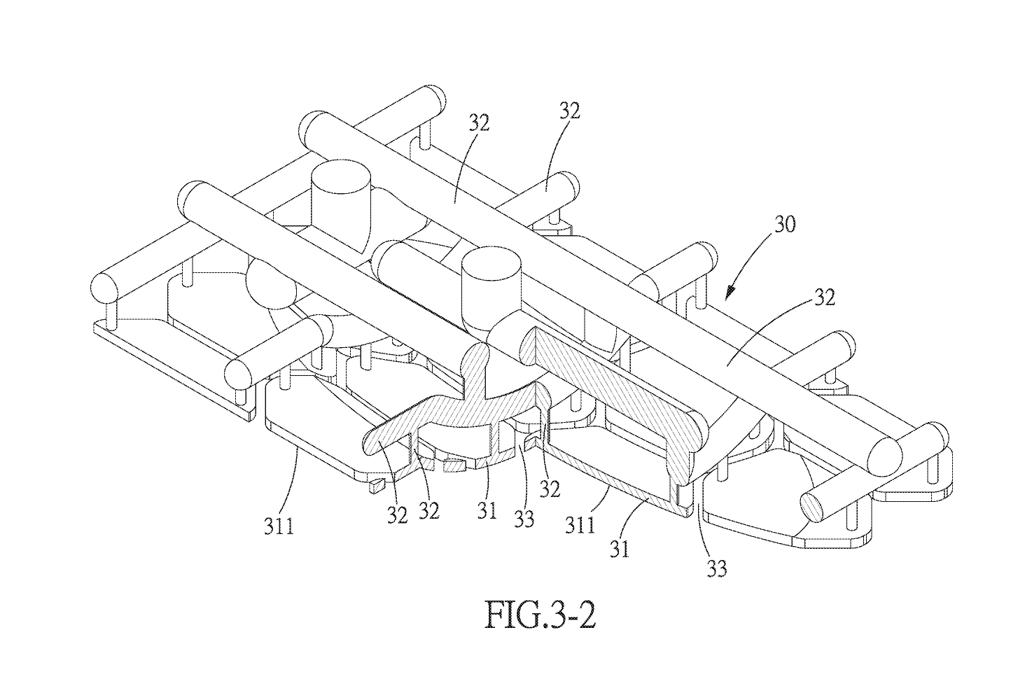

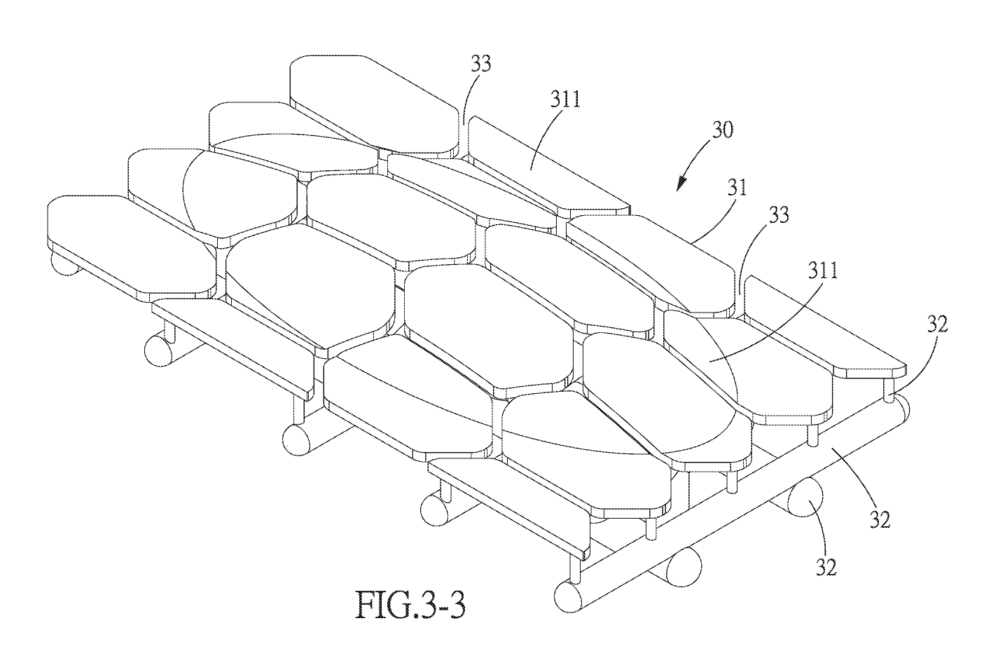

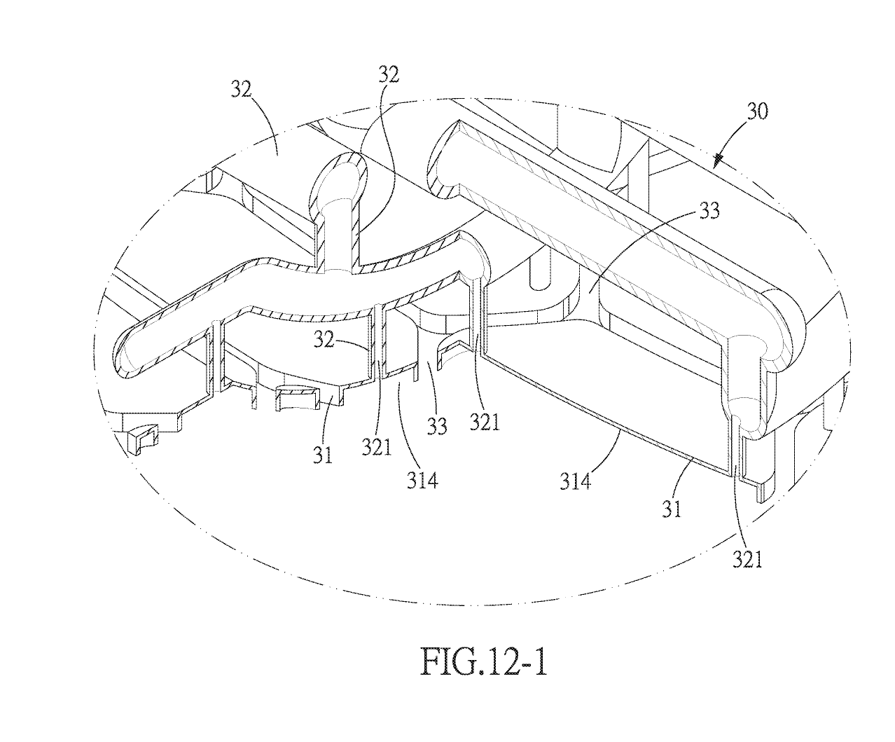

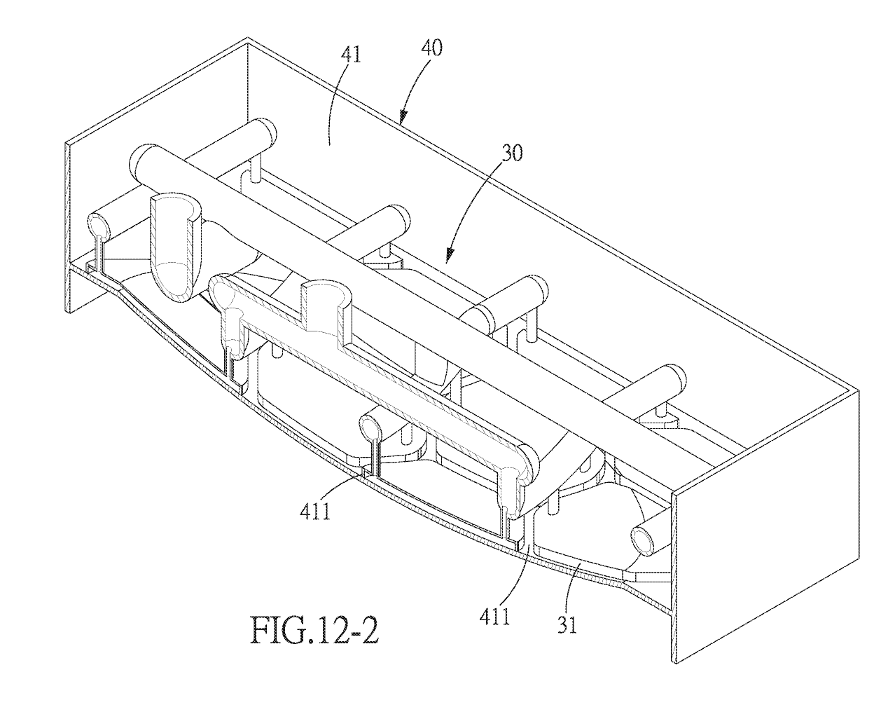

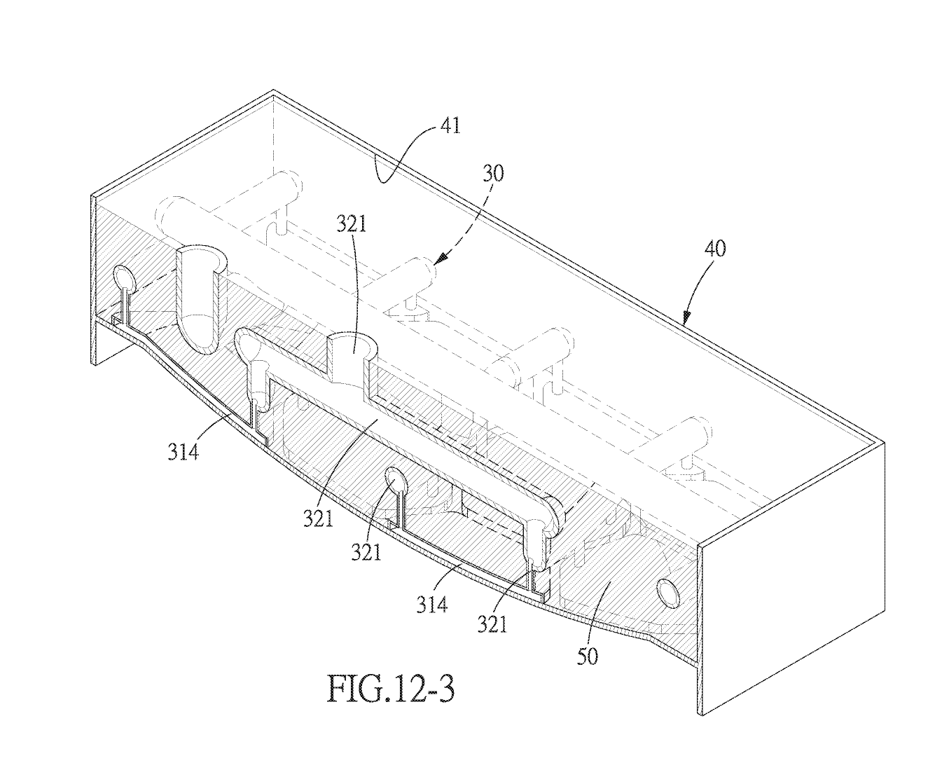

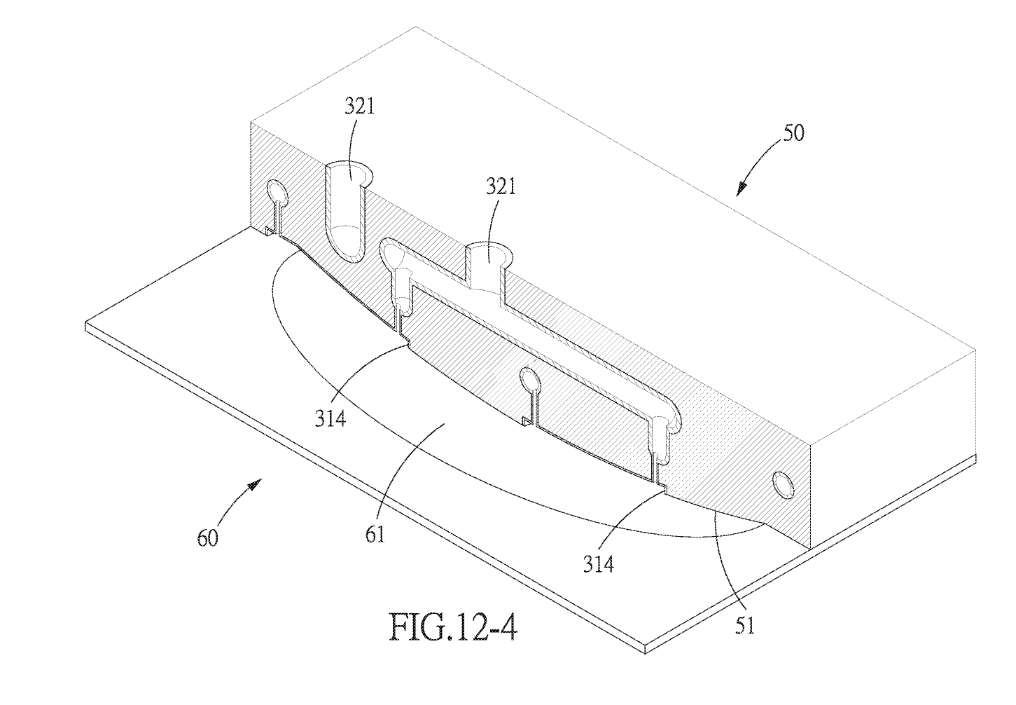

Moreover, as shown in FIG. 12-3, the forming method for a cooling system of a rapid heating mold in accordance with the first embodiment of the present invention, in the step 21 of preparing, the attachment portions 31 of the solid cooling waterway object 30 each include cooling grooves 314. Each of the subbranch portions 32 includes cooling passages 321 which do or do not communicate with the cooling grooves 314, so as to form the cooling waterway, which further reduces the material and cost of the solid cooling waterway object 30.

Referring to FIGS. 10-1 and 10-2, a forming method for a cooling system of a rapid heating mold in accordance with the second embodiment of the present invention is different from the first embodiment in the following aspects:

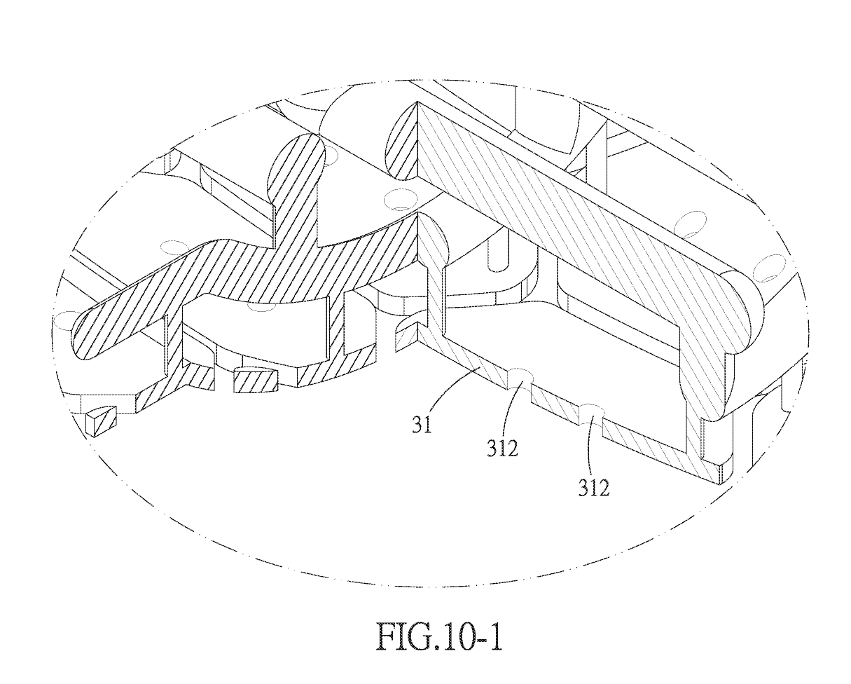

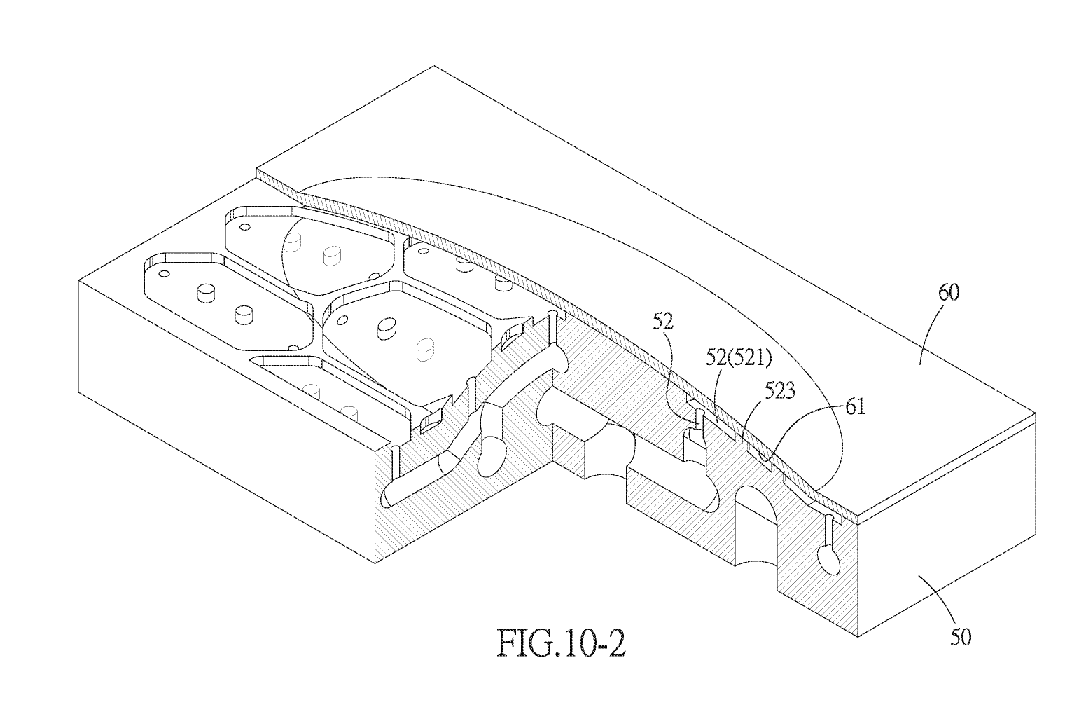

In the step of preparing, as shown in FIG. 10-1, the attachment portions 31 are each provided with two inserting holes 312, so that, after the step of heating, as shown in FIG. 10-2, the cooling waterway 52 (the cooling grooves 521) formed on the mold fixing layer 50 will be formed with two support portions 523 in the shape of the two inserting holes 312, and the top surface of each of the support portions 523 is abutted against the inner mold surface 61 of the mold layer 60, so as to enhance the structural strength of the mold layer 60.

Referring to FIGS. 3-1 and 8-1, a forming method for a cooling system of a rapid heating mold in accordance with the third embodiment of the present invention is different from the first embodiment in the following aspects:

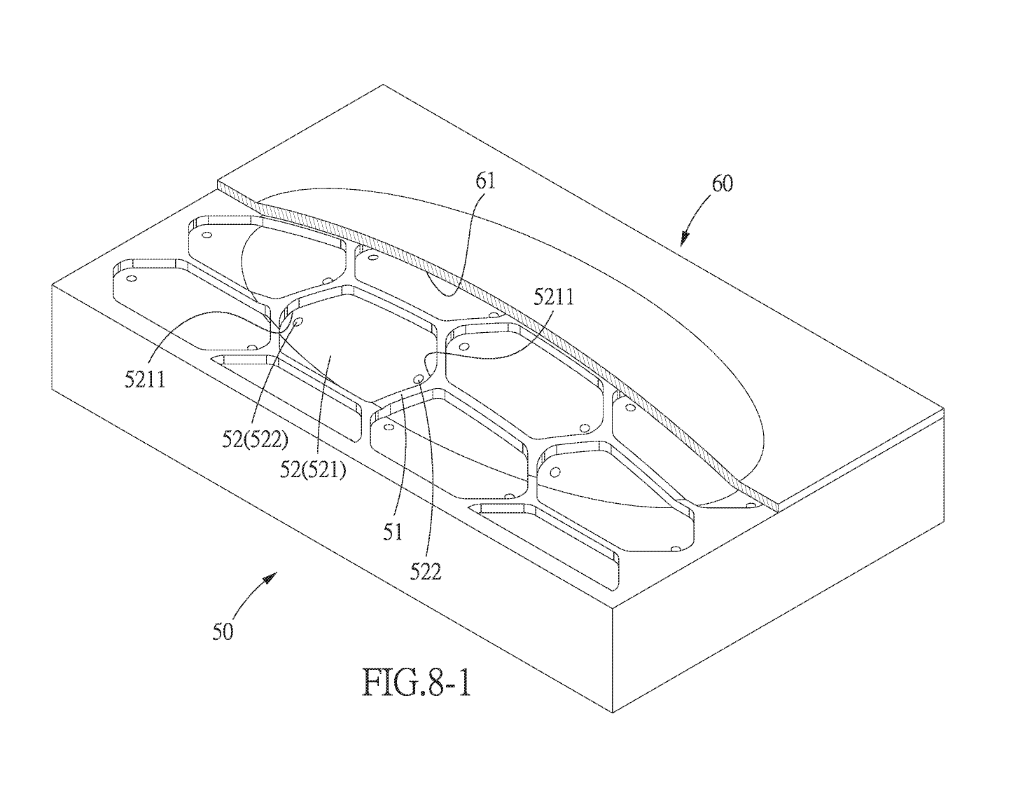

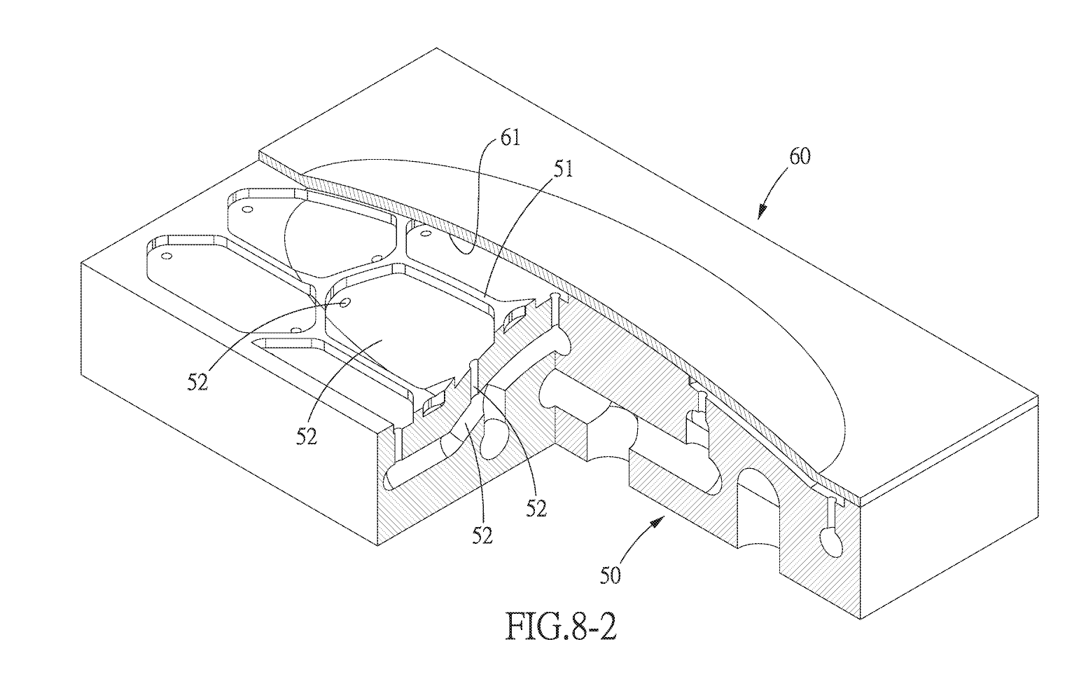

In the step of preparing, as shown in FIG. 3-1, the attachment portions 31 each include two shrink ends 313 which are connected to a corresponding one of the subbranch portions 32, so that, after the step of heating, as shown in FIG. 8-1, the cooling waterway 52 (the cooling grooves 521) formed in the shape of the attachment portions 31 will be formed with end portions 5211 in the shape of the shrink ends, and the cooling passages 522 (in the shape of the subbranch portions 32) in communication with the cooling grooves 521. By such arrangements, one of the cooling passages 522 serves as an air inlet, and the other cooling passage 522 serves as an air outlet, so that cooling liquid can be cleaned from one end portion 5211 to the other end portion 5211, and will finally be discharged via another cooling passage 522.

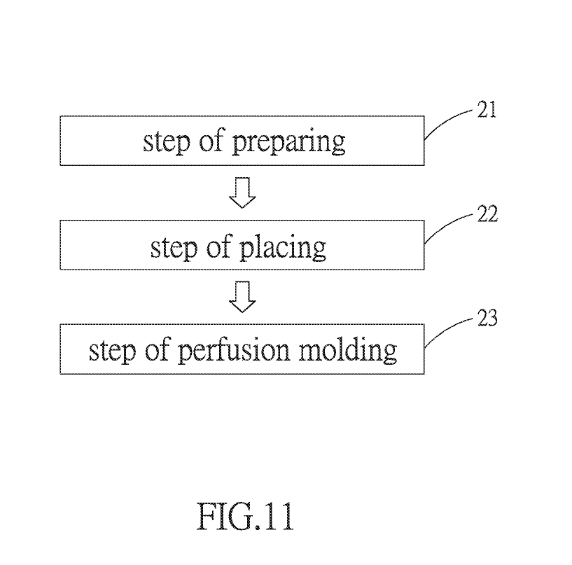

Referring to FIG. 11, a forming method for a cooling system of a rapid heating mold in accordance with the fourth embodiment of the present invention comprises the following steps: a step 21 of preparing, a step 22 of placing, and a step 23 of perfusion molding.

As shown in FIG. 12-1, the step of preparing includes: preparing a solid cooling waterway object 30, the solid cooling waterway object 30 comprises multiple interconnected attachment portions 31 and multiple subbranch portions 32. The attachment portions 31 of the solid cooling waterway object 30 each include cooling grooves 314, and each of the subbranch portions 32 includes cooling passages 321 which communicate with the cooling grooves 314, so as to form the cooling waterway. In this embodiment, the solid cooling watery object 30 is made by 3D printing, and there are intervals 33 between the attachment portions 31 of the solid cooling waterway object 30.

Referring to FIG. 12-2, the step of placing includes: placing the solid cooling waterway object 30 into a container 40 with a perfusion groove 41, and abutting the attachment portions 31 against the groove bottom surface 411 of the perfusion groove 41.

Referring to FIG. 12-3, the step of perfusion molding includes: perfusing perfusion material into the perfusion groove 41 of the container 40 to form a mold fixing layer 50 for covering the solid cooling waterway object 30 after cooling, so that the mold fixing layer 50 is provided with the cooling waterway formed by the cooling passages 321 and the cooling grooves 314.

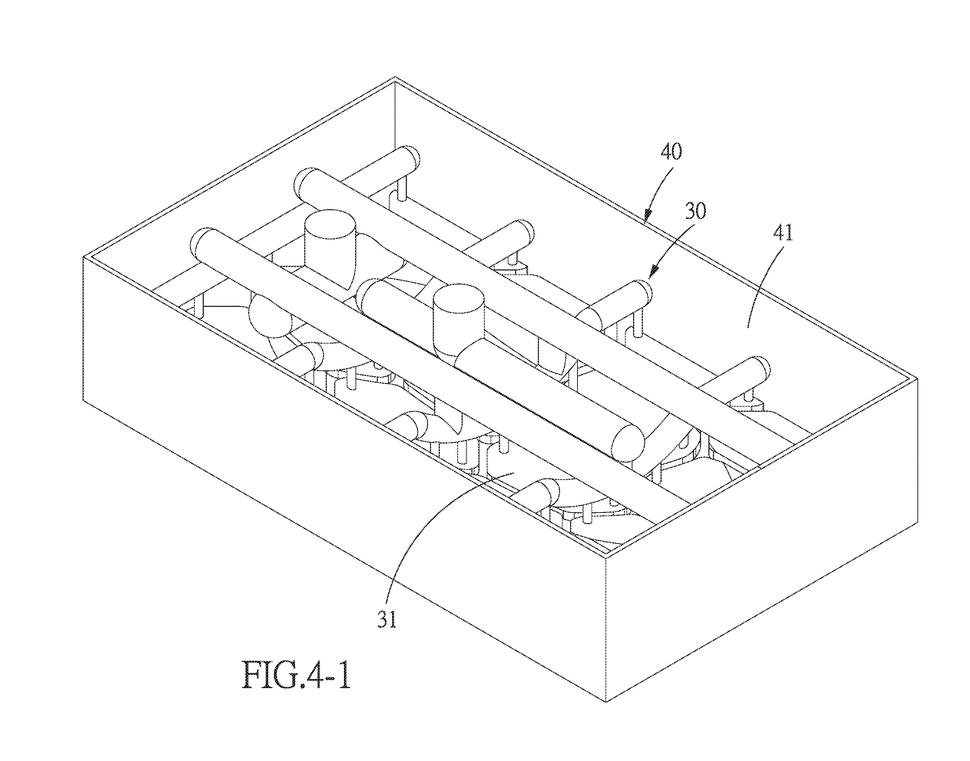

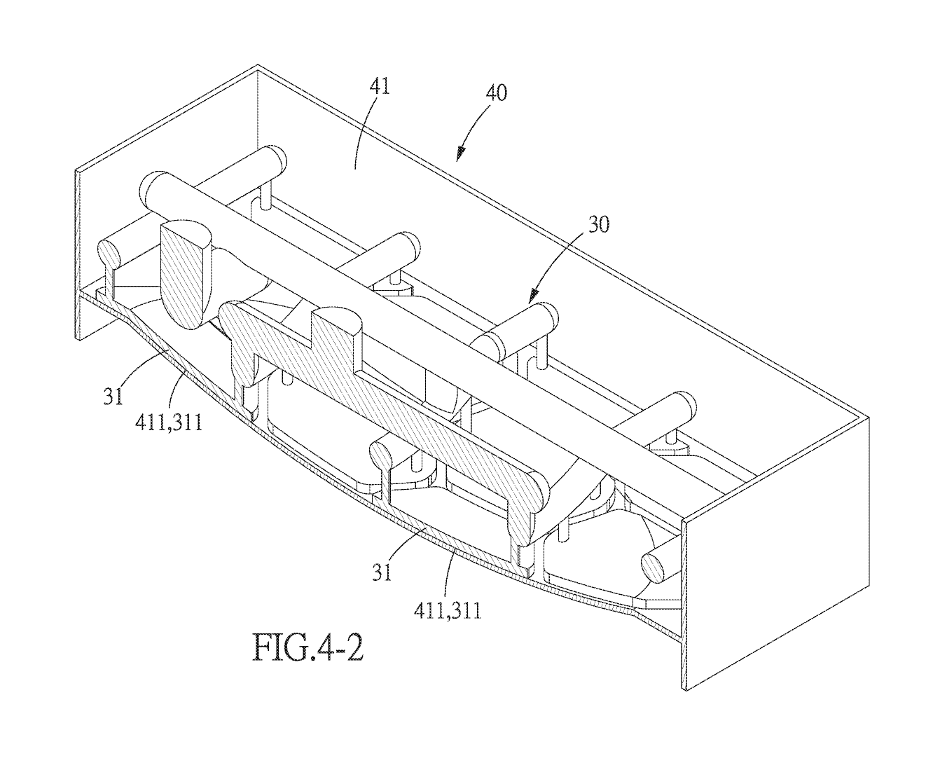

In this embodiment, as shown in FIGS. 12-4, the mold fixing layer 50 is taken out from the container 40 after the step of perfusing, the mold fixing layer 50 further includes the fixing layer mold surface 51 which is abutted against the inner mold surface 61 of the mold layer 60, and the cooling grooves 314 of the mold fixing layer 50 runs through the inner mold surface 61 of the mold layer 60.

By such arrangements, the fourth embodiment of the present invention has the same function as the first embodiment, and is also capable of forming any shaped cooling waterway as desired, and the cooling waterway is located close to the mold surface of the mold layer, achieving the advantages of easy manufacturing of the cooling waterway, and uniform cooling temperature distribution of the mold.

It is to be noted that the difference of the fourth embodiment from the first embodiment is that, in the step preparing, each of the attachment portions 31 of the solid cooling waterway object 30 is provided with the cooling grooves 314, and each of the subbranch portions 32 of the solid cooling waterway object 30 is provided with the cooling passages 321 which are in communication with the cooling grooves 314 to form the cooling waterway. The fourth embodiment requires no the step of removing, and does not require the melting point of the perfusion material to be lower than the melting point of the solid cooling waterway object 30, and the perfusion material does not have to be less corrosive than the solid cooling waterway object 30, which effectively reduces processing procedures.

In the step of perfusion molding, an open end of each of the cooling passages 321 can be sealed with a detachable plug (not shown) in order to prevent the perfusion material from flowing into the cooling passages 321 of the solid cooling waterway object 30, and after the step of perfusion molding is done, the plug can be removed. Before the step of perfusion molding, the solid cooling waterway object 30 is disposed in the container 40 with the perfusion groove 41, and the attachment portions 31 are abutted against the groove bottom surface 411 of the perfusion groove 41, therefore, the cooling grooves 314 should not be sealed with plugs.

Referring to FIGS. 13-1 and 13-2, a forming method for a cooling system of a rapid heating mold in accordance with the fifth embodiment of the present invention is different from the fourth embodiment in the following aspects:

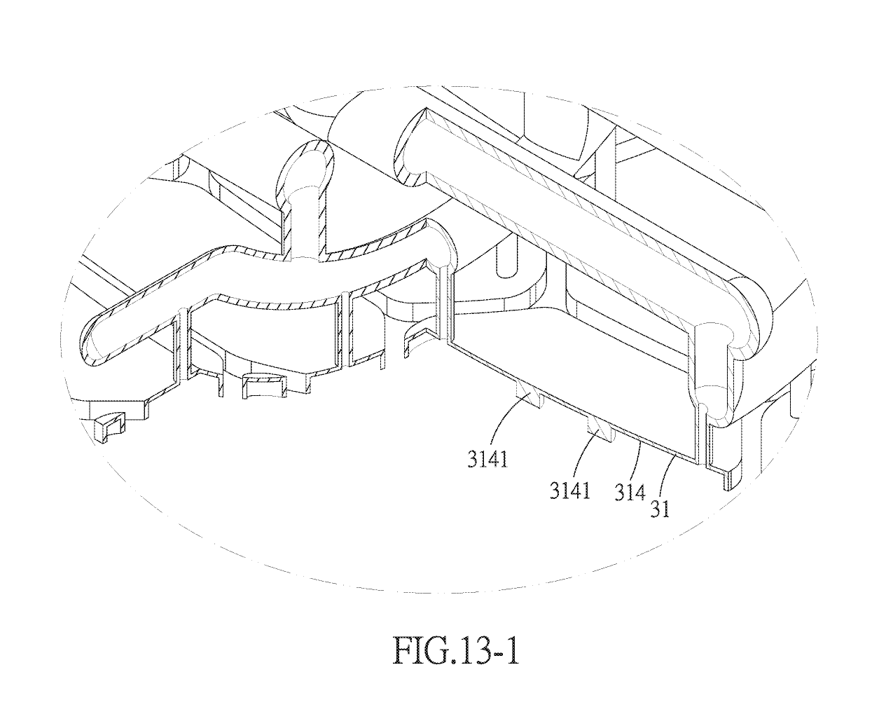

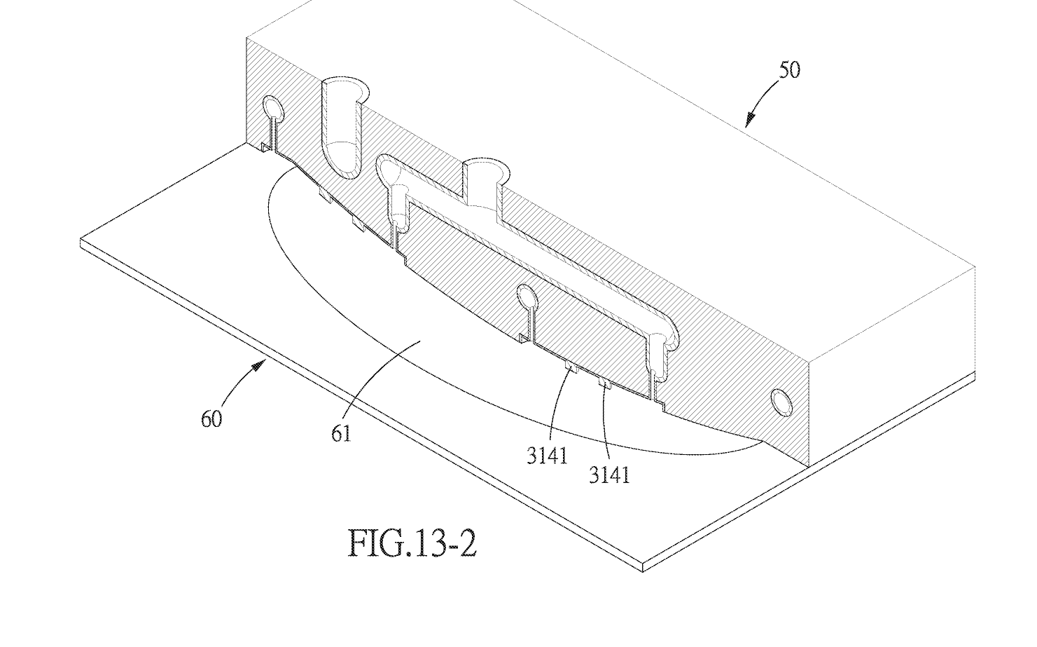

As shown in FIG. 13-1, in the step of preparing, there are two support portions 3141 in each of the cooling grooves 314 of the attachment portions 31, so that, after the step of perfusion molding as shown in FIG. 13-2, the two support portions 3141 remain in the cooling waterway formed in the mold fixing layer 50, and the top surface of each of the support portions 3141 is abutted against the inner mold surface 61 of the mold layer 60, so as to enhance the structural strength of the mold layer 60.

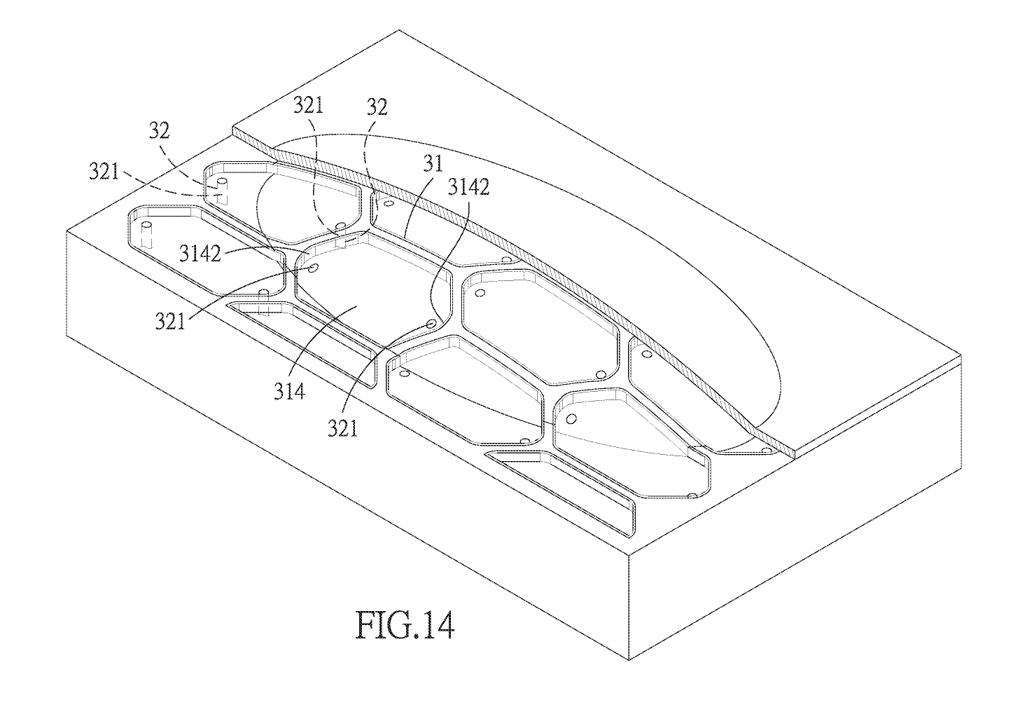

Referring to FIG. 14, a forming method for a cooling system of a rapid heating mold in accordance with the sixth embodiment of the present invention is different from the fourth embodiment in the following aspects:

In the step of preparing, the cooling grooves 314 of each the attachment portions 31 each include two shrink ends 3142 which are connected to a corresponding one of the cooling passages 321 of the subbranch portions 32. By such arrangements, one of the cooling passages 321 serves as an air inlet, and the other cooling passage 321 serves as an air outlet, so that cooling liquid can be cleaned from one shrink end 3142 to the other shrink end 3142, and will finally be discharged via another cooling passage 321.

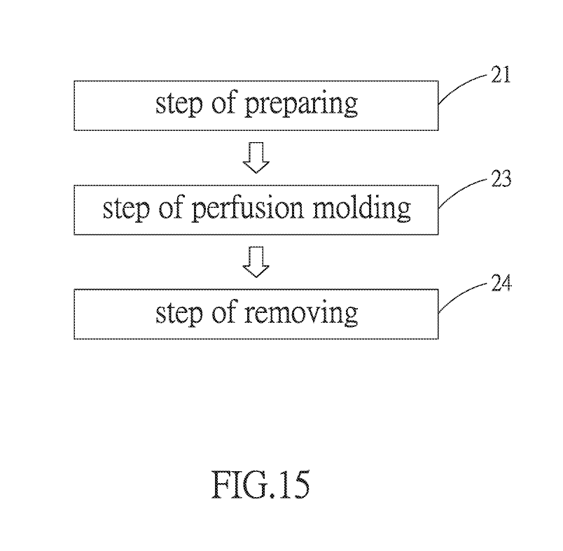

Referring to FIG. 15, a forming method for a cooling system of a rapid heating mold in accordance with the seventh embodiment of the present invention comprises the following steps: a step 21 of preparing, a step 23 of perfusion molding, and a step 24 of removing.

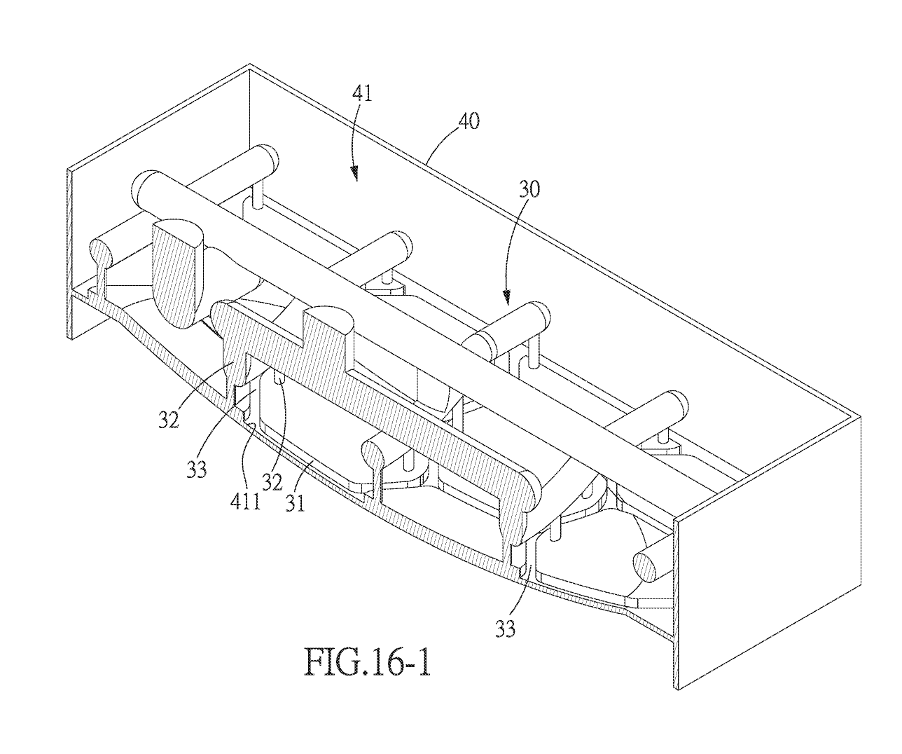

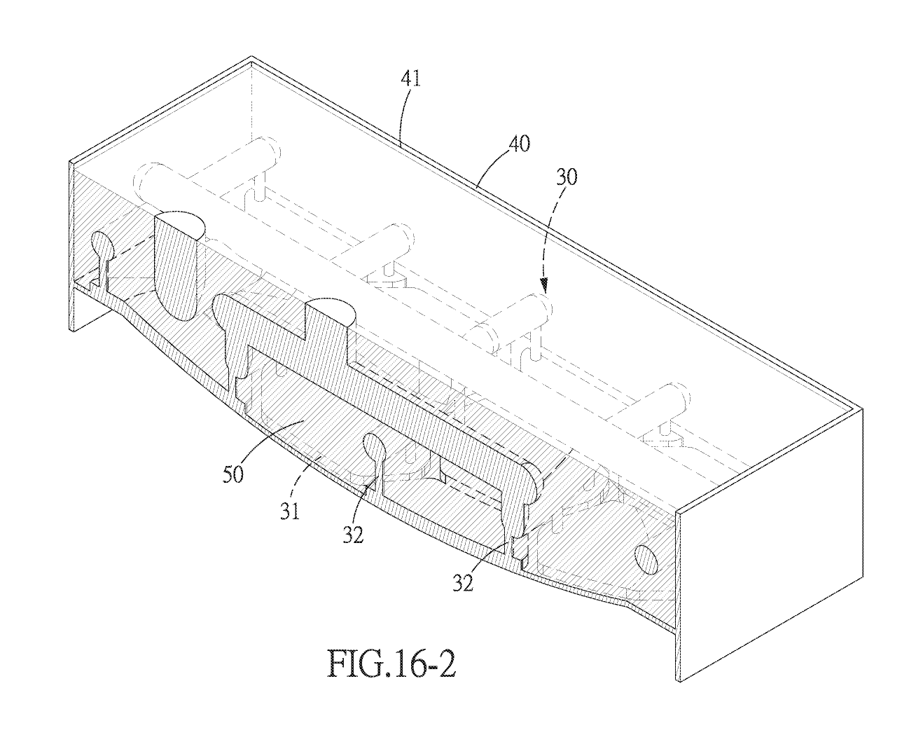

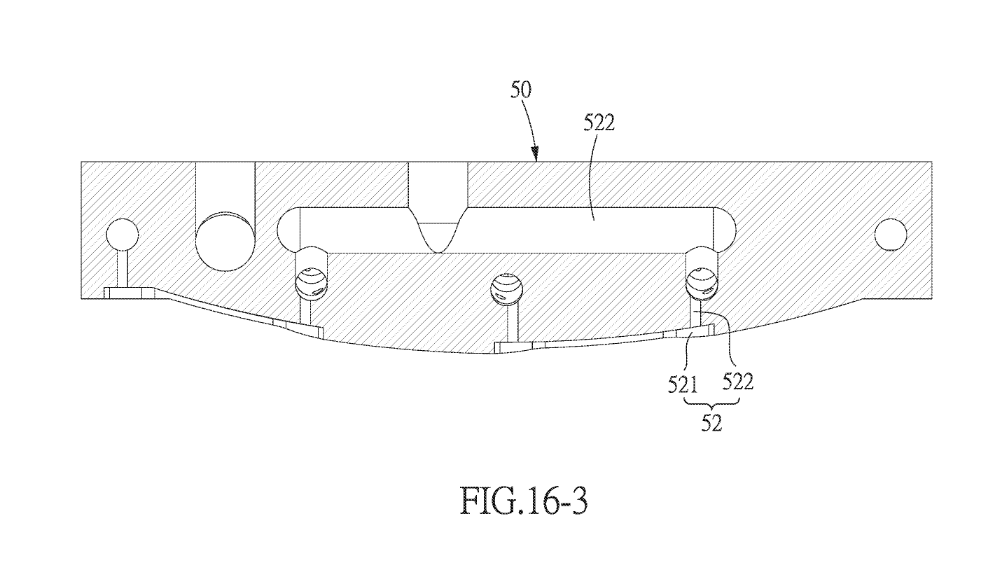

As shown in FIG. 16-1, the step of preparing includes: preparing a container 40 with a perfusion groove 41, a solid cooling waterway object 30 of a default cooling waterway integrally formed in the perfusion groove 41. The solid cooling waterway object 30 comprises multiple interconnected attachment portions 31 and multiple subbranch portions 32, and the attachment portions 31 are formed in the groove bottom surface 411 of the perfusion groove 41. In this embodiment, the solid cooling watery object 30 and the container are made by 3D printing, and there are intervals 33 between the attachment portions 31 of the solid cooling waterway object 30.

Referring to FIG. 16-2, the step of perfusion molding includes: preparing a perfusion material whose melting point is higher than the melting points of the container 40 and the solid cooling waterway object 30, perfusing the perfusion material into the perfusion groove 41 of the container 40 to form a mold fixing layer 50 for covering the solid cooling waterway object 30 after cooling.

As shown in FIGS. 16-2 and 16-3, the step of removing includes: heating the mold fixing layer 50 with a temperature lower than the melting point of the mold fixing layer 50 and higher than the melting points of the container 40 and the solid cooling waterway object 30, so that the solid cooling waterway object 30 and the container 40 are heated into a liquid or gas state and discharged out of the mold fixing layer 50, so as to form a cooling waterway 52 corresponding to (or in the shape of) the solid cooling waterway object 30 in the mold fixing layer 50, and the cooling waterway 52 is provided with cooling grooves 521 in the shape of the attachment portions 31 and the cooling passages 522 in the shape of the subbranch portions 32.

By such arrangements, the seventh embodiment of the present invention has the same function as the first embodiment, and is also capable of forming any shaped cooling waterway 52 as desired, and the cooling waterway 52 is located close to the mold surface of the mold layer, achieving the advantages of easy manufacturing of the cooling waterway 52, and uniform cooling temperature distribution of the mold.

It is to be noted that the difference of the seventh embodiment from the first embodiment is that the container 40 and the solid cooling waterway object 30 are formed simultaneously in the step preparing 21, without requiring an additional step of forming the container 40 and the step 22 of placing, which effectively reduces processing procedures.

Similarly, the step 23 of perfusion molding of the forming method for a cooling system of a rapid heating mold in accordance with the seventh embodiment of the present invention is to prepare a perfusion material which is less corrosive than the solid cooling waterway object 30. In the step 24 of removing, the mold fixing layer 50 is soaked with corrosive solution, and the corrosive solution does not erode the mold fixing layer 50 but erodes the solid cooling waterway object 30 only. In this way, the solid cooling waterway object 30 can also be turned into liquid or gas and discharged out of the mold fixing layer 50, so as to form the cooling waterway 52 in the shape of the solid cooling waterway object 30 in the mold fixing layer 50, and the cooling waterway 52 is provided with cooling grooves 521 in the shape of the attachment portions 31 and the cooling passages in the shape of the subbranch portions 32.

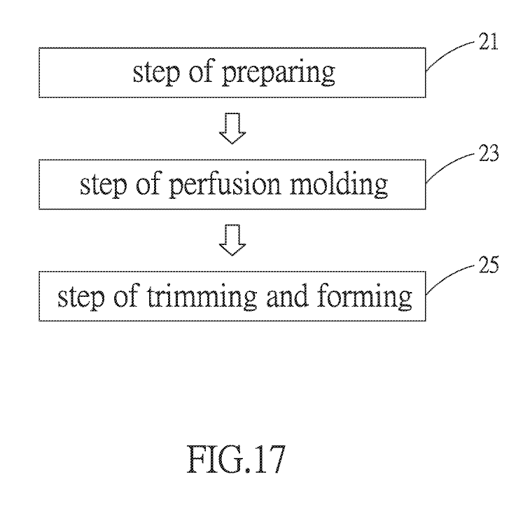

Referring to FIG. 17, a forming method for a cooling system of a rapid heating mold in accordance with the eighth embodiment of the present invention comprises the following steps: a step 21 of preparing, a step 23 of perfusion molding, and a step 25 of trimming and forming.

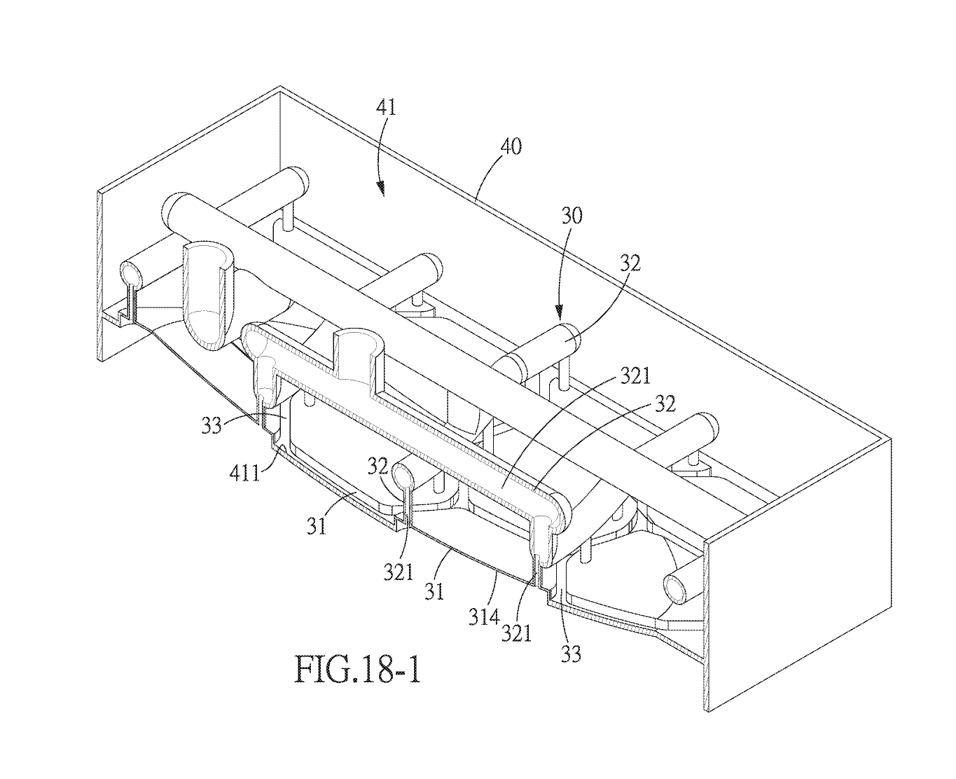

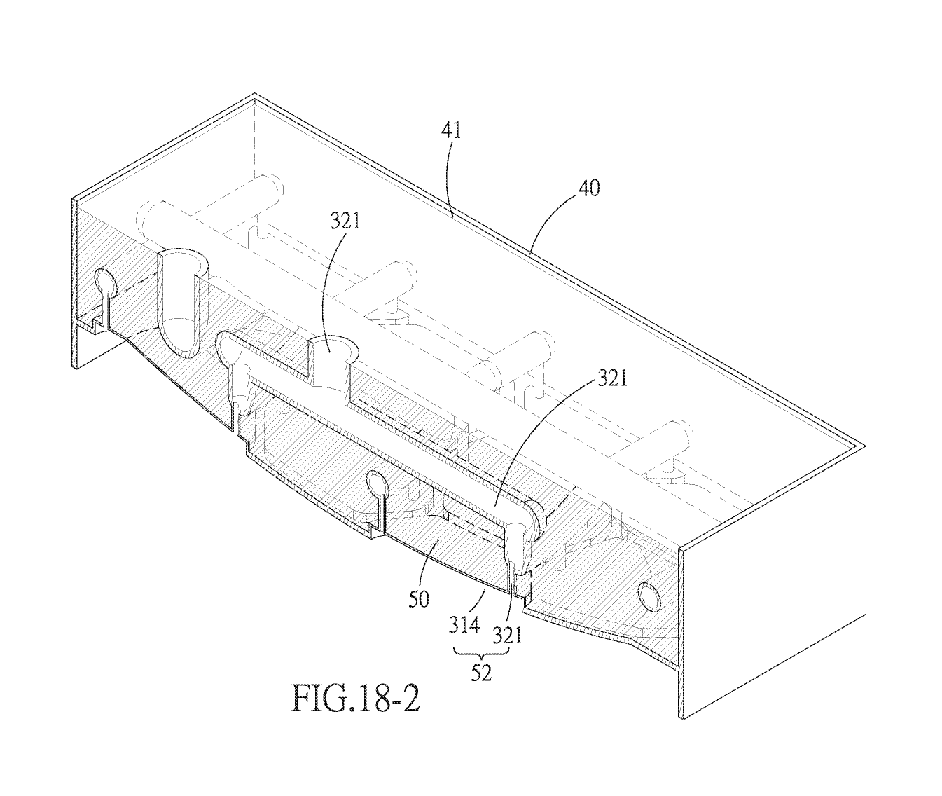

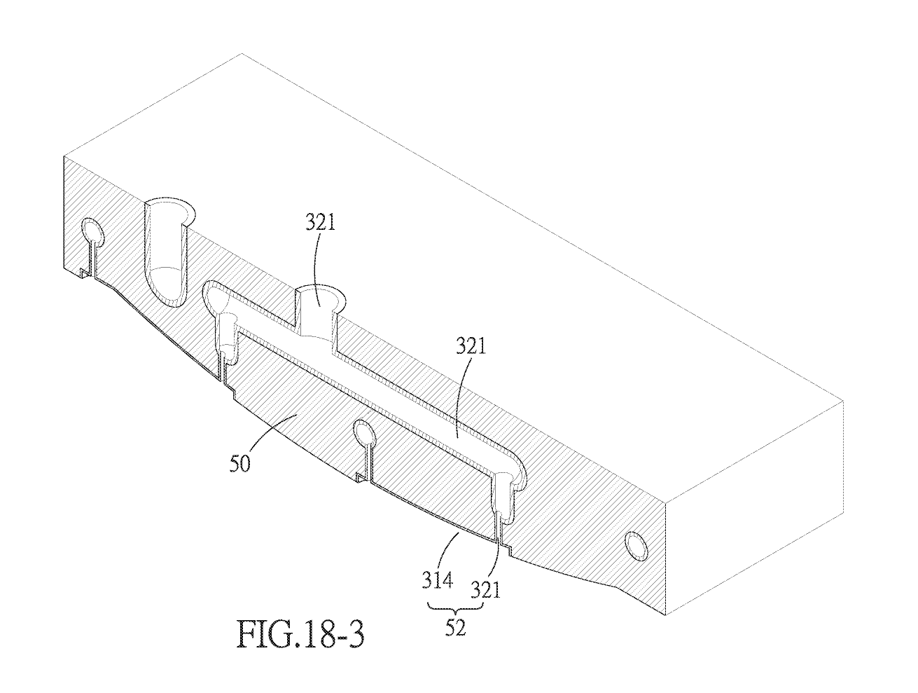

As shown in FIG. 18-1, the step of preparing includes: preparing a container 40 with a perfusion groove 41, a solid cooling waterway object 30 of a default cooling waterway integrally formed in the perfusion groove 41. The solid cooling waterway object 30 comprises multiple interconnected attachment portions 31 and multiple subbranch portions 32, and the attachment portions 31 are formed in the groove bottom surface 411 of the perfusion groove 41. Each of the subbranch portions 32 includes cooling passages 321 which communicate with the cooling grooves 314, so as to form the cooling waterway 52. In this embodiment, the solid cooling watery object 30 is made by 3D printing, and there are intervals 33 between the attachment portions 31 of the solid cooling waterway object 30.

Referring to FIG. 18-2, the step of perfusion molding includes: perfusing the perfusion material into the perfusion groove 41 of the container 40 to form a mold fixing layer 50 for covering the solid cooling waterway object 30 after cooling, so that the mold fixing layer 50 is provided with the cooling waterway formed by the cooling passages 321 and the cooling grooves 314.

As shown in FIGS. 18-2 and 18-3, the step of trimming and forming includes: trimming the container 40, so that the cooling grooves 314 and at least one of the cooling passages 321 in the mold fixing layer 50 can communicate with outside.

By such arrangements, the eighth embodiment of the present invention has the same function as the first embodiment, and is also capable of forming any shaped cooling waterway 52 as desired, and the cooling waterway 52 is located close to the mold surface of the mold layer, achieving the advantages of easy manufacturing of the cooling waterway 52, and uniform cooling temperature distribution of the mold.

While we have shown and described various embodiments in accordance with the present invention, it is clear to those skilled in the art that further embodiments may be made without departing from the scope of the present invention.

What is claimed is:

1. A forming method for a cooling system of a rapid heating mold, characterized in that comprises:
a step of preparing including: preparing a solid cooling waterway object of a default cooling waterway, the solid cooling waterway object comprises multiple interconnected attachment portions and multiple subbranch portions;
a step of placing including: placing the solid cooling waterway object into a container with a perfusion groove, and abutting the attachment portions against a groove bottom surface of the perfusion groove;
a step of perfusion molding including: preparing a perfusion material, perfusing the perfusion material into the perfusion groove of the container to form a mold fixing layer for covering the solid cooling waterway object after cooling; and
a step of removing including: taking out the mold fixing layer and processing the mold fixing layer to turn the solid cooling waterway object into liquid or gas which is discharged out of the mold fixing layer, so as to form a cooling waterway corresponding to the solid cooling waterway object in the mold fixing layer.

2. The forming method for the cooling system of the rapid heating mold as claimed in claim 1, characterized in that the solid cooling watery object is made by 3D printing, and there are intervals between the attachment portions of the solid cooling waterway object.

3. The forming method for the cooling system of the rapid heating mold as claimed in claim 1, characterized in that the step of perfusion molding includes: preparing a perfusion material whose melting point is higher than a melting point of the solid cooling waterway object, and the step of removing is to heat the mold fixing layer with a temperature lower than a melting point of the mold fixing layer and higher than the melting point of the solid cooling waterway object.

4. The forming method for the cooling system of the rapid heating mold as claimed in claim 1, characterized in that the step of perfusion molding is to prepare a perfusion material which is less corrosive than the solid cooling waterway object, the step of removing is to soak the mold fixing layer in a corrosive solution, and the corrosive solution does not erode the mold fixing layer but erodes the solid cooling waterway object only.

5. The forming method for the cooling system of the rapid heating mold as claimed in claim 1, characterized in that the attachment portions of the solid cooling waterway object each include cooling grooves, and each of the subbranch portions includes cooling passages which communicate with the cooling grooves, so as to form the cooling waterway.

6. A forming method for a cooling system of a rapid heating mold, characterized in that comprises:
a step of preparing including: preparing a solid cooling waterway object, the solid cooling waterway object comprises multiple interconnected attachment portions and multiple subbranch portions, the attachment portions of the solid cooling waterway object each include cooling grooves, and each of the subbranch portions includes cooling passages which communicate with the cooling grooves, so as to form a cooling waterway;
a step of placing including: placing the solid cooling waterway object into a container with a perfusion groove, and abutting the attachment portions against a groove bottom surface of the perfusion groove; and
a step of perfusion molding including: perfusing a perfusion material into the perfusion groove of the container to form a mold fixing layer for covering the solid cooling waterway object after the perfusion material cools down, so that the mold fixing layer is provided with the cooling waterway formed by the cooling passages and the cooling grooves.

7. The forming method for the cooling system of the rapid heating mold as claimed in claim 6, characterized in that the solid cooling watery object is made by 3D printing, and there are intervals between the attachment portions of the solid cooling waterway object.

8. A forming method for a cooling system of a rapid heating mold, characterized in that comprises:
a step of preparing including: preparing a container with a perfusion groove, and a solid cooling waterway object of a default cooling waterway integrally formed in the perfusion groove, the solid cooling waterway object comprises multiple interconnected attachment portions and multiple subbranch portions, and the attachment portions are formed in a groove bottom surface of the perfusion groove;
a step of perfusion molding including: preparing a perfusion material, and perfusing the perfusion material into the perfusion groove of the container to form a mold fixing layer for covering the solid cooling waterway object after cooling; and
a step of removing including: processing the mold fixing layer to turn the solid cooling waterway object and the container into a liquid or gas which is discharged out of the mold fixing layer, so as to form a cooling waterway corresponding to the solid cooling waterway object in the mold fixing layer.

9. The forming method for the cooling system of the rapid heating mold as claimed in claim 8, characterized in that the solid cooling watery object and the container are made by 3D printing, and there are intervals between the attachment portions of the solid cooling waterway object.

10. The forming method for the cooling system of the rapid heating mold as claimed in claim 8, characterized in that the step of perfusion molding is to prepare a perfusion material whose melting point is higher than melting points of the container and the solid cooling waterway object, and the step of removing is to heat the mold fixing layer with a temperature lower than the melting point of the mold fixing layer and higher than the melting points of the container and the solid cooling waterway object.

11. The forming method for the cooling system of the rapid heating mold as claimed in claim 8, characterized in that the step of perfusion molding is to prepare a perfusion material which is less corrosive than the solid cooling waterway object and the container, the step of removing is to soak the mold fixing layer in a corrosive solution, and the corrosive solution does not erode the mold fixing layer but erodes the solid cooling waterway object and the container only.

12. A forming method for a cooling system of a rapid heating mold, characterized in that comprises:
a step of preparing including: preparing a container with a perfusion groove, a solid cooling waterway object of a default cooling waterway integrally formed in the perfusion groove, the solid cooling waterway object comprises multiple interconnected attachment portions and multiple subbranch portions, and the attachment portions are formed in the groove bottom surface of the perfusion groove and include cooling grooves, each of the subbranch portions includes cooling passages which communicate with the cooling grooves, so as to form a cooling waterway;
a step of perfusion molding including: perfusing a perfusion material into the perfusion groove of the container to form a mold fixing layer for covering the solid cooling waterway object after cooling, so that the mold fixing layer is provided with the cooling waterway formed by the cooling passages and the cooling grooves; and
a step of trimming and forming including: trimming the container, so that the cooling grooves and at least one of the cooling passages in the mold fixing layer communicate with outside.

13. The forming method for the cooling system of the rapid heating mold as claimed in claim 12, characterized in that the solid cooling watery object and the container are made by 3D printing, and there are intervals between the attachment portions of the solid cooling waterway object.
